(19) United States
(12) Patent Application Publication
(10) Pub. No.: US 2024/0233039 A1
(43) Pub. Date: Jul. 11, 2024

(54) INCREASING AUDIENCE EXPOSURE FOR BEGINNING CREATORS

(71) Applicant: Meta Platforms, Inc., Menlo Park, CA (US)

(72) Inventors: Thomas Bredillet, Amherst, NH (US); Ivan Medvedev, New York, NY (US)

(21) Appl. No.: 17/464,423

(22) Filed: Sep. 1, 2021

(51) Int. Cl. G06Q 50/00; G06K 9/62; G06N 20/00

(52) U.S. Cl. CPC G06Q 50/01; G06K 9/6256; G06N 20/00

(57) ABSTRACT

Methods, systems, and storage media for promoting social media content are disclosed. Exemplary implementations may: receive user-created content for a social media platform; track a performance of the user-created content; in response to the performance breaching a predefined threshold, promote the user-created content to a higher tier level, the higher tier level associated with a higher performance threshold than the predefined threshold; track the performance of the user-created content at the higher tier level; in response to the performance breaching the higher performance threshold of the higher tier level, promote the user-created content to an even higher tier level, the even higher tier level associated with an even higher performance threshold than the previous threshold; training a machine learning model on example input-output pairs, each example input-output pair comprising a representation of the user-created content and the performance that breaches at least the predefined threshold; and determining, through the machine learning model, whether a popularity of the user-created content will grow exponentially.

### TECHNICAL FIELD

The present disclosure generally relates to increasing audience exposure for beginning creators, and more particularly to promoting social media content.

### BACKGROUND

With contemporary social media platforms, users can generate and share content. Users may be motivated to create content for a variety of reasons such as simple altruism, the possibility of publicity (e.g., to become a paid “influencer”), the desire to gain new knowledge, or to help bring about social reform. In any case, social media platforms benefit greatly from user generated content because, in many ways, these platforms exist so that users can consume content provided by other users. If users of a given social media platform perceive low-quality or irrelevant content regularly being presented to them, however, that social media platform may risk losing regular users.

### BRIEF SUMMARY

The subject disclosure provides for systems and methods for increasing audience exposure for beginning creators. A user is allowed to have the opportunity to receive positive feedback, as a new content creator on a social media platform, from larger group of other users relative to the user's own social media connections. For example, if a user receive positive feedback from the larger group when they begin creating content, they may be more likely to continue to create content and strive for higher-quality content, instead of potentially being discouraged by the minimal feedback they might receive from only their own smaller network.

One aspect of the present disclosure relates to a method for promoting social media content. The method may include receiving user-created content for a social media platform. The method may include tracking a performance of the user-created content. The method may include, in response to the performance breaching a predefined threshold, promoting the user-created content to a higher tier level, the higher tier level associated with a higher performance threshold than the predefined threshold. The method may include tracking the performance of the user-created content at the higher tier level. The method may include, in response to the performance breaching the higher performance threshold of the higher tier level, promoting the user-created content to an even higher tier level, the even higher tier level associated with an even higher performance threshold than the previous threshold. The method may include training a machine learning model on example input-output pairs, each example input-output pair comprising a representation of the user-created content and the performance that breaches at least the predefined threshold. The method may include determining, through the machine learning model, whether a popularity of the user-created content will grow exponentially.

Another aspect of the present disclosure relates to a system configured for promoting social media content. The system may include one or more hardware processors configured by machine-readable instructions. The processor(s) may be configured to receive user-created content for a social media platform. The processor(s) may be configured to track a performance of the user-created content. The processor(s) may be configured to, in response to the performance breaching a predefined threshold, promote the user-created content to a higher tier level, the higher tier level associated with a higher performance threshold than the predefined threshold. The processor(s) may be configured to track the performance of the user-created content at the higher tier level. The processor(s) may be configured to, in response to the performance breaching the higher performance threshold of the higher tier level, promote the user-created content to an even higher tier level, the even higher tier level associated with an even higher performance threshold than the previous threshold. The processor(s) may be configured to train a machine learning model on example input-output pairs, each example input-output pair comprising a representation of the user-created content and the performance that breaches at least the predefined threshold. The processor(s) may be configured to determine, through the machine learning model, whether a popularity of the user-created content will grow exponentially.

Yet another aspect of the present disclosure relates to a non-transient computer-readable storage medium having instructions embodied thereon, the instructions being executable by one or more processors to perform a method for promoting social media content. The method may include receiving user-created content for a social media platform. The method may include tracking a performance of the user-created content. The method may include, in response to the performance breaching a predefined threshold, promoting the user-created content to a higher tier level, the higher tier level associated with a higher performance threshold than the predefined threshold. The method may include tracking the performance of the user-created content at the higher tier level. The method may include, in response to the performance breaching the higher performance threshold of the higher tier level, promoting the user-created content to an even higher tier level, the even higher tier level associated with an even higher performance threshold than the previous threshold. The method may include training a machine learning model on example input-output pairs, each example input-output pair comprising a representation of the user-created content and the performance that breaches at least the predefined threshold. The method may include determining, through the machine learning model, whether a popularity of the user-created content will grow exponentially.

Still another aspect of the present disclosure relates to a system configured for promoting social media content. The system may include means for receiving user-created content for a social media platform. The system may include means for tracking a performance of the user-created content. The system may include means for, in response to the performance breaching a predefined threshold, promoting the user-created content to a higher tier level, the higher tier level associated with a higher performance threshold than the predefined threshold. The system may include means for tracking the performance of the user-created content at the higher tier level. The system may include means for, in response to the performance breaching the higher performance threshold of the higher tier level, promoting the user-created content to an even higher tier level, the even higher tier level associated with an even higher performance threshold than the previous threshold. The system may include means for training a machine learning model on example input-output pairs, each example input-output pair comprising a representation of the user-created content and the performance that breaches at least the predefined threshold. The system may include means for determining, through the machine learning model, whether a popularity of the user-created content will grow exponentially.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example process flow for elevating user-created content to higher tiers of distribution via a social media platform, in accordance with one or more implementations.

FIG. 2 illustrates an example content distribution path for user-created content ascending different levels of content distribution, in accordance with one or more implementations.

FIG. 3 illustrates another example content distribution path for user-created content ascending different levels of content distribution, in accordance with one or more implementations.

FIG. 4 illustrates an example gap rule for a pattern and frequency of promoted content being included among organically sourced content, in accordance with one or more implementations.

FIG. 5 illustrates a set of gap rules for patterns and frequencies of promoted content being included among organically sourced content, in accordance with one or more implementations.

FIG. 6 illustrates an example process flow for providing viewer users with promoted user-created content, in accordance with one or more implementations.

FIG. 7 illustrates an example process flow for adding promoted user-created content to a viewer users' content queue, in accordance with one or more implementations.

FIG. 8 illustrates an example process flow for adding promoted user-created content to a content queue associated with a cluster of viewer users, in accordance with one or more implementations.

FIG. 9 illustrates an example process flow for managing promoted user-created content in a content queue associated with a cluster of viewer users, in accordance with one or more implementations

FIG. 10 illustrates a system configured for increasing audience exposure for beginning creators, in accordance with one or more implementations

FIG. 11 illustrates an example flow diagram for increasing audience exposure for beginning creators, according to certain aspects of the disclosure.

FIG. 12 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

On existing social media platforms, amateur content creators may be sensitive to feedback they receive from other users (e.g., likes, comments, reads, etc.). If a new amateur content creator does not receive supportive feedback early, she may be discouraged and create less and less content. As such, a potential star content creator may fail to reach her audience through her high-quality content.

The subject disclosure provides for systems and methods for increasing audience exposure for beginning creators. A user is allowed to have the opportunity to receive positive feedback, as a new content creator on a social media platform, from larger group of other users relative to the user's own social media connections. For example, if a user receive positive feedback from the larger group when they begin creating content, they may be more likely to continue to create content and strive for higher-quality content, instead of potentially being discouraged by the minimal feedback they might receive from only their own smaller network.

Implementations described herein address these and other problems by providing a promotion service to give validation to amateur content creators by ensuring their media get targeted distribution and to give chances to amateur content creators to become influencers within a social media ecosystem. In exemplary implementations, the performance of user-created content may be tracked to determine whether it breaches a predefined threshold. If so, the user-created content may be promoted to other users at a higher level. This track/promote cycle may be repeated such that the user-created content makes it to a series of higher levels of promotion to wider and wider audiences. The ability to get such increased distribution may encourage a new content creator to continue to create great content.

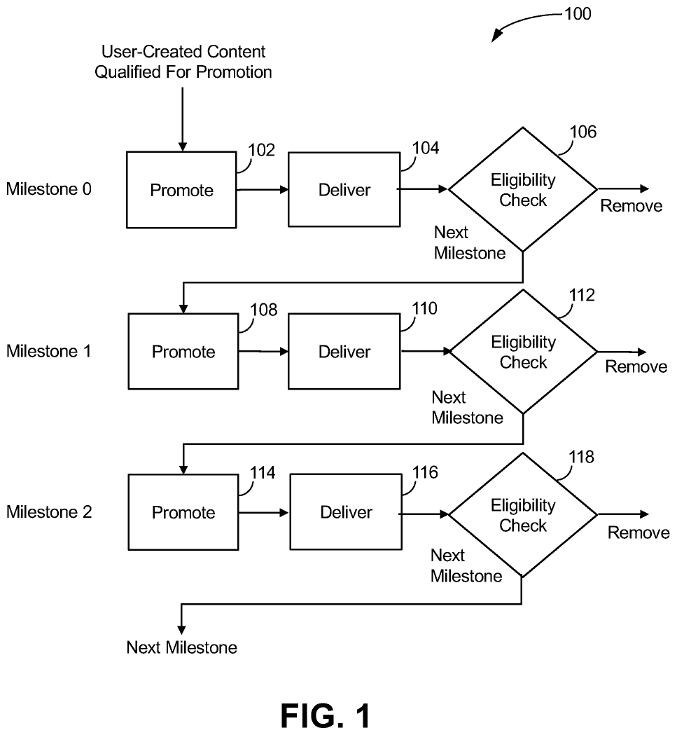

FIG. 1 illustrates an example process flow 100 for elevating user-created content to higher tiers of distribution via a social media platform, in accordance with one or more implementations. At a step 102, user-created content that is qualified to be promoted may be received for promotion at an initial milestone. At a step 104, the user-created content is delivered for potential impressions (e.g., view, like, comment, share, etc.) from a first subset of users. At a step 106, a performance of the user-created content may be determined. For example, if a target number of impressions was twenty, but the actual number of impressions was less than twenty, then the user created content may be removed from process flow 100. If the actual number of impressions was twenty or more, the user content may be elevated to the next milestone.

At a step 108, the user created content may be promoted at the next milestone. At a step 110, the user-created content is delivered for potential impressions (e.g., view, like, comment, share, etc.) from a second subset of users. The second subset including more users than the first subset. At a step 112, a performance of the user-created content may be determined. For example, if a target number of impressions was fifty, but the actual number of impressions was less than fifty, then the user created content may be removed from process flow 100. If the actual number of impressions was fifty or more, the user content may be elevated to the following milestone.

At a step 114, the user created content may be promoted at the following milestone. At a step 116, the user-created content is delivered for potential impressions (e.g., view, like, comment, share, etc.) from a third subset of users. The third subset including more users than the second subset. At a step 118, a performance of the user-created content may be determined. For example, if a target number of impressions was fifty, but the actual number of impressions was less than fifty, then the user created content may be removed from process flow 100. If the actual number of impressions was fifty or more, the user content may be elevated to a further milestone, and so on.

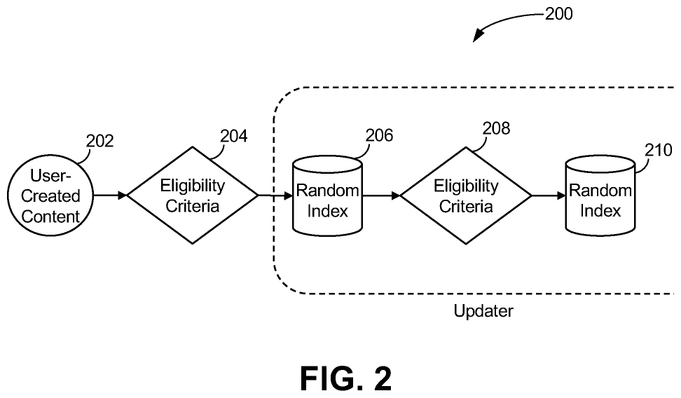

FIG. 2 illustrates an example content distribution path 200 for user-created content ascending different levels of content distribution, in accordance with one or more implementations. At a step 202, content may be created by a user (e.g., user posts media to social media platform). At a step 204, an eligibility check may be performed on the user-created content. The eligibility check may be based on various criteria. Examples of such criteria may include one or more of being among the nth percentile of content impressions and/or breaching a performance threshold, and/or other criteria. At a step 206, a random target audience may be obtained from a random index. The random target audience may be selected from among all users or a subset of users on the social media platform. The random target audience may be associated with a target number of impressions in be achieved by the user-created content while it is being promoted. At a step 208, promotion criteria may be applied to determine a performance of the user-created content in relation to the random target audience. At a step 210, a second, larger random target audience may be obtained from a random index. Again, the second random target audience may be selected from among all users or a subset of users on the social media platform. The second random target audience may be associated with a second target number of impressions in be achieved by the user-created content while it is being promoted. The second target number may be greater than the first target number of impressions. The process may iterate to larger and larger target numbers with larger and larger random target audiences.

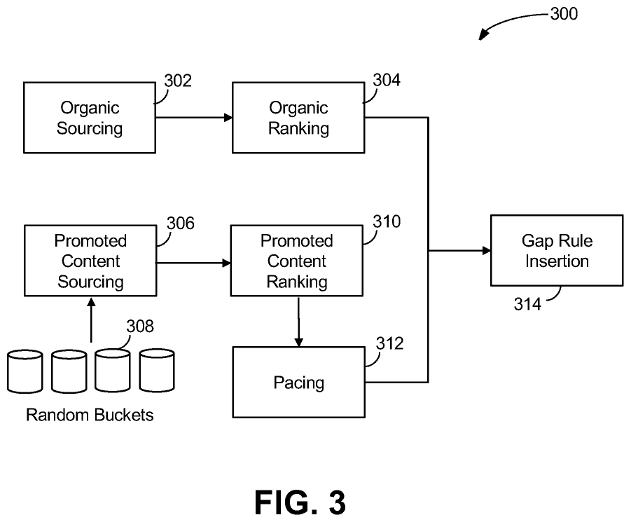

FIG. 3 illustrates another example content distribution path 300 for user-created content ascending different levels of content distribution, in accordance with one or more implementations. At a step 302, content relevant to a given user may be sourced organically. For example, relevant content may include content that is similar to content that the given user has interacted with in the past (e.g., viewed, liked, commented on, shared, etc.). At a step 304, the organically sourced content may be ranked. The ranking may be based on a prediction of a likelihood of the given user interacting with individual organically sourced content items. The result may include a list of ranked organic content. At a step 306, content relevant to the given user may be sourced from content that needs to be promoted. The content that needs to be promoted may be organized into different random buckets 308. For example, the content that needs to be promoted may need to achieve more impressions before being elevated to the next milestone or tier of promotion (see, e.g., FIGS. 1 and 2). At a step 310, the sourced promoted content may be ranked. The ranking may be based on a prediction of a likelihood of the given user interacting with individual promoted content items. The result may include a list of ranked promoted content. At a step 312, a pace at which the promoted content should be added to the given user's social media feed for potential impressions. At a step 314, one or more gap rules may be applied to determine when promoted content from the promoted content list is injected into a feed that includes organic content from the organic content list.

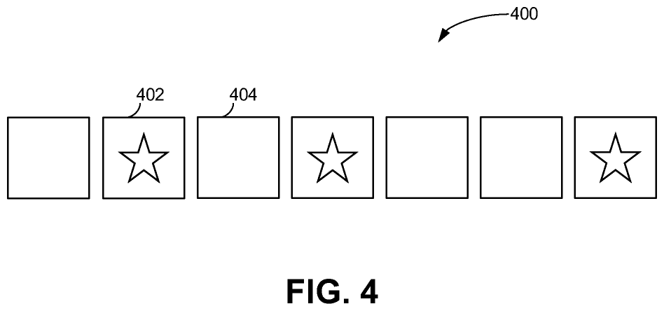

FIG. 4 illustrates an example gap rule 400 for a pattern and frequency of promoted content 402 being included among organically sourced content 404, in accordance with one or more implementations. The pattern established by the gap rule 400 may be repeated for content presented in a user's social media feed.

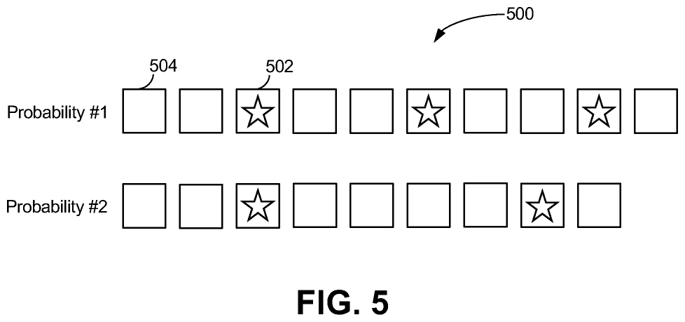

FIG. 5 illustrates a set of gap rules 500 for patterns and frequencies of promoted content 502 being included among organically sourced content 504, in accordance with one or more implementations. The gap rules 500 correspond to two different probabilities that the next milestone will be met. The gap rules 500 may change based on or be affected by how much time is left until the promoted content's promotional period expires.

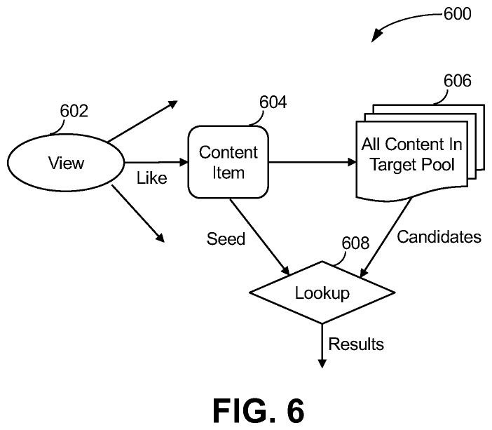

FIG. 6 illustrates an example process flow 600 for providing viewer users with promoted user-created content, in accordance with one or more implementations. At a step 602, a user may like a content item 604 (e.g., in their social media feed). At a step 606, content that needs to be promoted may be accessed. At a step 608, a lookup may be performed on the content that needs to be promoted by using the content item 604 as a seed for the look up. In some implementations, a kth nearest-neighbor (KNN) lookup may be performed to obtain promoted content that may be relevant or of interest to the user.

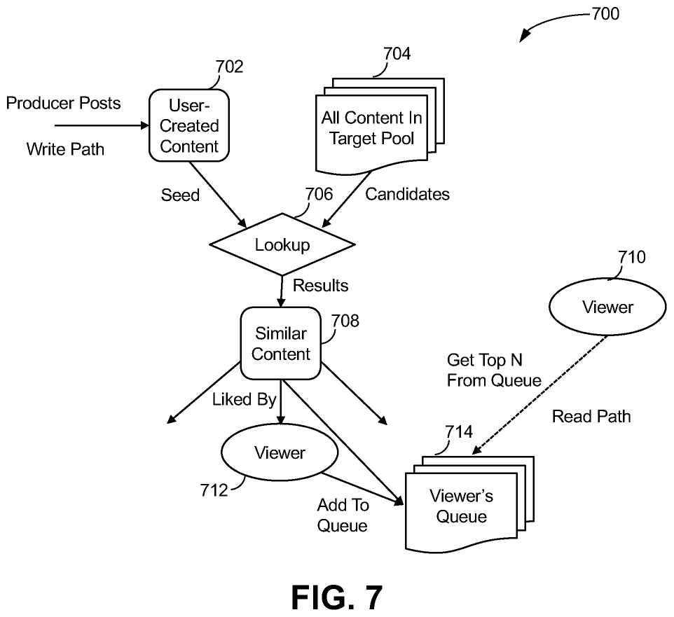

FIG. 7 illustrates an example process flow 700 for adding promoted user-created content to a viewer users' content queue, in accordance with one or more implementations. At a step 702, a user posts user-created content. At a step 704, content that needs to be promoted may be accessed. At a step 706, a lookup may be performed on the content that needs to be promoted by using the user-created content as a seed for the look up. In some implementations, a kth nearest-neighbor (KNN) lookup may be performed to obtain promoted content that may be relevant or of interest to the user. At a step 708, content that is similar to the user-created content may be obtained and presented to a user 712. The user 712 and another user 710 may view content from viewers queue 714.

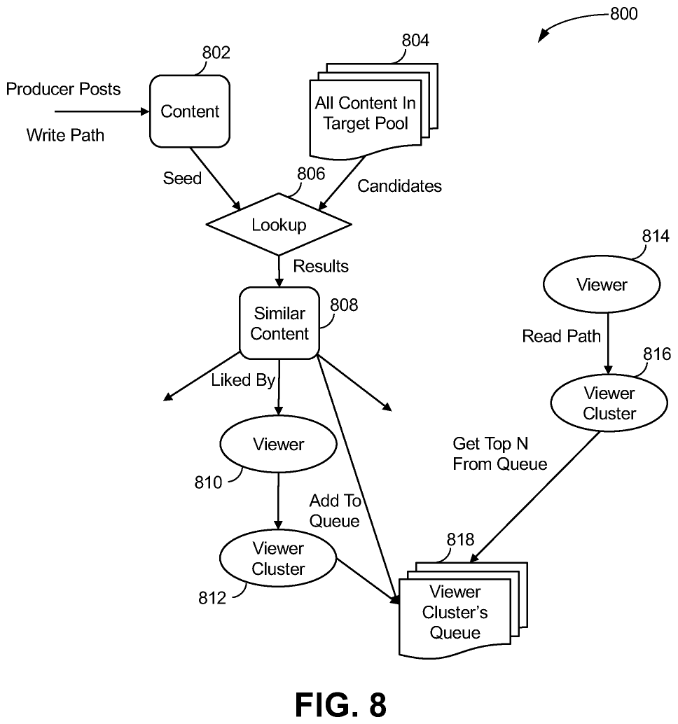

FIG. 8 illustrates an example process flow 800 for adding promoted user-created content to a content queue associated with a cluster of viewer users, in accordance with one or more implementations. At a step 802, a user posts user-created content. At a step 804, content that needs to be promoted may be accessed. At a step 806, a lookup may be performed on the content that needs to be promoted by using the user-created content as a seed for the look up. In some implementations, a kth nearest-neighbor (KNN) lookup may be performed to obtain promoted content that may be relevant or of interest to the user. At a step 808, content that is similar to the user-created content may be obtained and liked by a user 810. The user 810 may be added to a user cluster 812 with similar interests. A user 814 may be added to a user cluster 816 will different common interests. Users associated with the user cluster 812 and the user cluster 816 may be exposed to content in viewer's cluster queue 818.

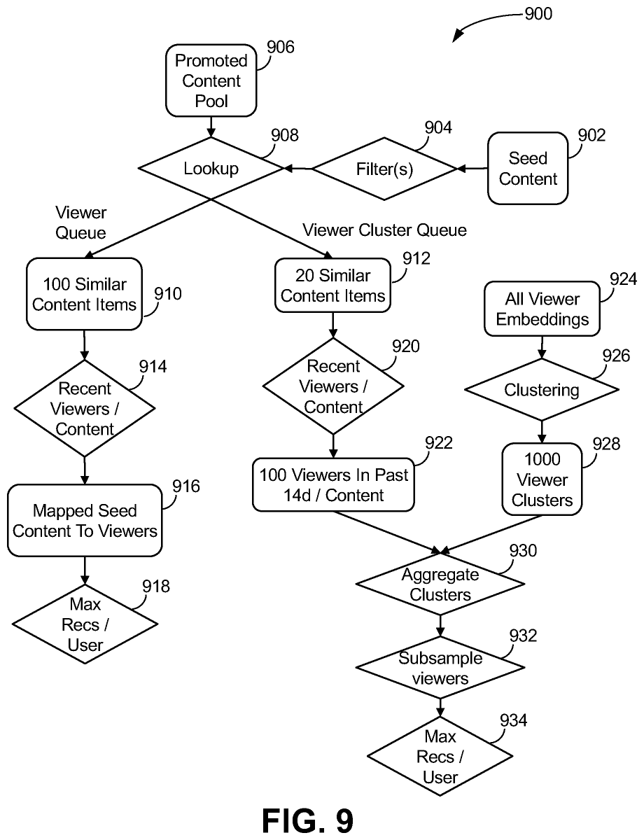

FIG. 9 illustrates an example process flow 900 for managing promoted user-created content in a content queue associated with a cluster of viewer users, in accordance with one or more implementations. At a step 902, seed content may be provided. At a step 904, one or more filters may be applied to the content (e.g., account, age, public, etc.). At a step 906, content that needs to be promoted may be accessed. At a step 908, a lookup may be performed on the content that needs to be promoted by using the seed content as a seed for the look up. In some implementations, a kth nearest-neighbor (KNN) lookup may be performed to obtain promoted content that may be relevant or of interest to the user. At a step 910, one hundred similar content items that need to be promoted may be identified. At a step 912, twenty similar content items that need to be promoted may be identified. At a step 914, recent engaged viewer users per similar content item may be determined. At a step 916, the seed content may be mapped to viewer users. At a step 918, a maximum number of recommendations per user may be determined. At a step 920, recent engaged viewer users per similar content item may be determined. At a step 922, one hundred viewer users may be determined who viewed the content items in the last fourteen days. At a step 924, all viewer users' embeddings may be determined. At a step 926, k-means clustering may be applied to the viewer user embeddings. At a step 928, one thousand user clusters may be determined. At a step 930, user clusters may be aggregated. For a given cluster being aggregated, its cluster weight may be proportional to the number of users belonging to that cluster. At a step 932, a subsample of viewer users may be determined. At a step 934, a maximum number of recommendations per user may be determined.

The disclosed system(s) address a problem in traditional increasing audience exposure for beginning creators techniques tied to computer technology, namely, the technical problem of limited content distribution on social media platforms for content-creator users with relatively small numbers of social media connections where limited feedback may contribute to discouraging further content creation. The disclosed system solves this technical problem by providing a solution also rooted in computer technology, namely, by providing for obfuscating an exact location of a user. The disclosed subject technology further provides improvements to the functioning of the computer itself because it improves processing and efficiency in increasing audience exposure for beginning creators.

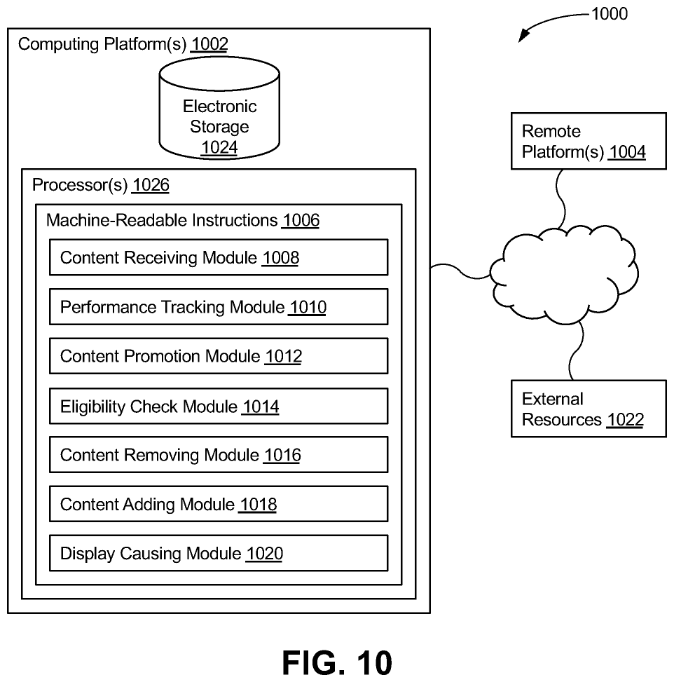

FIG. 10 illustrates a system 1000 configured for increasing audience exposure for beginning creators, according to certain aspects of the disclosure. In some implementations, system 1000 may include one or more computing platforms 1002. Computing platform(s) 1002 may be configured to communicate with one or more remote platforms 1004 according to a client/server architecture, a peer-to-peer architecture, and/or other architectures. Remote platform(s) 1004 may be configured to communicate with other remote platforms via computing platform(s) 1002 and/or according to a client/server architecture, a peer-to-peer architecture, and/or other architectures. Users may access system 1000 via remote platform(s) 1004.

Computing platform(s) 1002 may be configured by machine-readable instructions 1006. Machine-readable instructions 1006 may include one or more instruction modules. The instruction modules may include computer program modules. The instruction modules may include one or more of content receiving module 1008, performance tracking module 1010, content promotion module 1012, eligibility check module 1014, content removing module 1016, content adding module 1018, display causing module 1020, and/or other instruction modules.

Content receiving module 1008 may be configured to receive user-created content for a social media platform. By way of non-limiting example, the social media platform may include an online platform on which users can build social connections with other users who share similar personal or career interests, activities, backgrounds, or real-life connections. In some implementations, by way of non-limiting example, the content may include at least one of a video, photo, image, multimedia, linked content, text, or post.

Machine learning may be utilized to predict whether the user-created content will go viral (e.g., a popularity of the user-created content growing exponentially within a limited time period, the user-created content being shared to and/or viewed by thousands/millions of users within a limited time period). For example, the user-created content may go viral when it has been shared (e.g., via email, social media, etc.) to spread quickly to thousands/millions of people online in a short period of time (e.g., a week, a day, an hour, a minute, etc.), relative to a size of a population of users. According to aspects, user-created content may go viral when viewed by thousands of users quickly on a smaller social network, and/or when viewed by millions of users over a longer period of time on a larger social network. A machine learning model may be trained on example input-output pairs, a given example input-output pair including a representation of user-created content in an expected format of the machine learning model and corresponding performance statistics that breach a predetermined performance threshold. Unseen inputs to the machine learning model may include a representation of the user-created content. The result of the unseen inputs being processed by the machine learning model may include performance statistics predicted by the trained machine learning model. A prediction of whether the user-created content will go viral may include an indication as to whether the user-created content will go viral based on the predicted performance statistics. The user-created content going viral may include the user-created content achieving performance statistics that breach a predetermined performance threshold.

Performance tracking module 1010 may be configured to track a performance of the user-created content. By way of non-limiting example, the performance may be determined based on at least one of clicks, likes, comments, shares, views, or reads. Tracking the performance of the user-created content may include recording consumption statistics attributed to the user-created content.

Content promotion module 1012 may be configured to, in response to the performance breaching a predefined threshold, promote the user-created content to a higher tier level. The higher tier level may be associated with a higher performance threshold than the predefined threshold. In some implementations, each higher tier level may include a larger group of users than a previous tier level.

Performance tracking module 1010 may be configured to track the performance of the user-created content at the higher tier level. Tracking the performance of the user-created content at the higher tier level may include recording consumption statistics attributed to the user-created content.

Content promotion module 1012 may be configured to, in response to the performance breaching the higher performance threshold of the higher tier level, promote the user-created content to an even higher tier level, the even higher tier level associated with an even higher performance threshold than the previous threshold.

Eligibility check module 1014 may be configured to perform an eligibility check when the user-created content is posted. The eligibility check may include a determination as to whether the user-created content is eligible for being promoted. The eligibility check may include determining whether a user associated with the user-created content is an influencer user. A given influencer user may include a user who has a large number of followers. A given influencer user may include a user who uses endorsements and/or product placement as a means to monetize their social media presence.

Content removing module 1016 may be configured to remove the user-created content from a curated group when the performance fails to breach the predefined threshold.

Content adding module 1018 may be configured to add the user-created content to a curated group where the user-created content would have a high probability of performing above the predefined threshold (e.g., good performance). The curated group may represent a cluster of users. Clustering users may be performed by using a trained machine learning model. Individual users may be represented by a vector to assist in clustering. By way of non-limiting example, the curated group may include users with similar personal or career interests, activities, backgrounds, social media connections, or real-life connections to each other. The high probability of good performance may include a probability that breaches a predetermined threshold probability of the user-created content having performance that breaches a predetermined performance threshold. The high probability of good performance may be determined by a trained machine learning model. The high probability of good performance may be determined through a set of rules.

In some implementations, a curated list may include at least the user-created content. In some implementations, by way of non-limiting example, the curated list may further include other user-created content that measurably appeals to users with similar personal or career interests, activities, backgrounds, social media connections, or real-life connections to each other. In some implementations, appeal may be measured based on historical performance of similar user-created content.

Display causing module 1020 may be configured to cause display of the performance through a user interface.

In some implementations, computing platform(s) 1002, remote platform(s) 1004, and/or external resources 1022 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 1002, remote platform(s) 1004, and/or external resources 1022 may be operatively linked via some other communication media.

A given remote platform 1004 may include one or more processors configured to execute computer program modules. The computer program modules may be configured to enable an expert or user associated with the given remote platform 1004 to interface with system 1000 and/or external resources 1022, and/or provide other functionality attributed herein to remote platform(s) 1004. By way of non-limiting example, a given remote platform 1004 and/or a given computing platform 1002 may include one or more of a server, a desktop computer, a laptop computer, a handheld computer, a tablet computing platform, a NetBook, a Smartphone, a gaming console, and/or other computing platforms.

External resources 1022 may include sources of information outside of system 1000, external entities participating with system 1000, and/or other resources. In some implementations, some or all of the functionality attributed herein to external resources 1022 may be provided by resources included in system 1000.

Computing platform(s) 1002 may include electronic storage 1024, one or more processors 1026, and/or other components. Computing platform(s) 1002 may include communication lines, or ports to enable the exchange of information with a network and/or other computing platforms. Illustration of computing platform(s) 1002 in FIG. 10 is not intended to be limiting. Computing platform(s) 1002 may include a plurality of hardware, software, and/or firmware components operating together to provide the functionality attributed herein to computing platform(s) 1002. For example, computing platform(s) 1002 may be implemented by a cloud of computing platforms operating together as computing platform(s) 1002.

Electronic storage 1024 may comprise non-transitory storage media that electronically stores information. The electronic storage media of electronic storage 1024 may include one or both of system storage that is provided integrally (i.e., substantially non-removable) with computing platform(s) 1002 and/or removable storage that is removably connectable to computing platform(s) 1002 via, for example, a port (e.g., a USB port, a firewire port, etc.) or a drive (e.g., a disk drive, etc.). Electronic storage 1024 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 1024 may include one or more virtual storage resources (e.g., cloud storage, a virtual private network, and/or other virtual storage resources). Electronic storage 1024 may store software algorithms, information determined by processor(s) 1026, information received from computing platform(s) 1002, information received from remote platform(s) 1004, and/or other information that enables computing platform(s) 1002 to function as described herein.

Processor(s) 1026 may be configured to provide information processing capabilities in computing platform(s) 1002. As such, processor(s) 1026 may include one or more of a digital processor, an analog processor, a digital circuit designed to process information, an analog circuit designed to process information, a state machine, and/or other mechanisms for electronically processing information. Although processor(s) 1026 is shown in FIG. 10 as a single entity, this is for illustrative purposes only. In some implementations, processor(s) 1026 may include a plurality of processing units. These processing units may be physically located within the same device, or processor(s) 1026 may represent processing functionality of a plurality of devices operating in coordination. Processor(s) 1026 may be configured to execute modules 1008, 1010, 1012, 1014, 1016, 1018, and/or 1020, and/or other modules. Processor(s) 1026 may be configured to execute modules 1008, 1010, 1012, 1014, 1016, 1018, and/or 1020, and/or other modules by software; hardware; firmware; some combination of software, hardware, and/or firmware; and/or other mechanisms for configuring processing capabilities on processor(s) 1026. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 1008, 1010, 1012, 1014, 1016, 1018, and/or 1020 are illustrated in FIG. 10 as being implemented within a single processing unit, in implementations in which processor(s) 1026 includes multiple processing units, one or more of modules 1008, 1010, 1012, 1014, 1016, 1018, and/or 1020 may be implemented remotely from the other modules. The description of the functionality provided by the different modules 1008, 1010, 1012, 1014, 1016, 1018, and/or 1020 described below is for illustrative purposes, and is not intended to be limiting, as any of modules 1008, 1010, 1012, 1014, 1016, 1018, and/or 1020 may provide more or less functionality than is described. For example, one or more of modules 1008, 1010, 1012, 1014, 1016, 1018, and/or 1020 may be eliminated, and some or all of its functionality may be provided by other ones of modules 1008, 1010, 1012, 1014, 1016, 1018, and/or 1020. As another example, processor(s) 1026 may be configured to execute one or more additional modules that may perform some or all of the functionality attributed below to one of modules 1008, 1010, 1012, 1014, 1016, 1018, and/or 1020.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

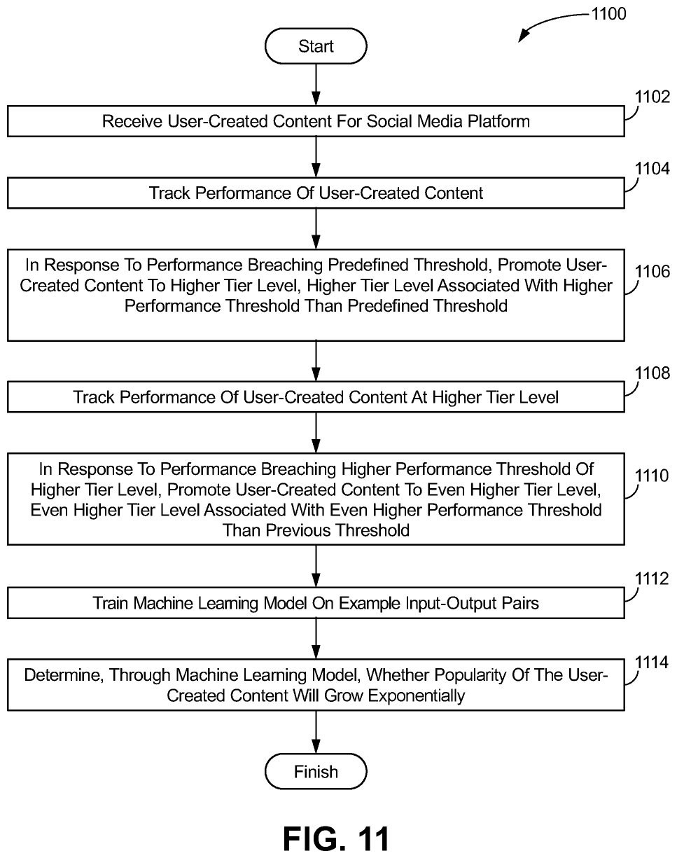

FIG. 11 illustrates an example flow diagram (e.g., process 1100) for increasing audience exposure for beginning creators, according to certain aspects of the disclosure. For explanatory purposes, the example process 1100 is described herein with reference to FIGS. 1-13. Further for explanatory purposes, the steps of the example process 1100 are described herein as occurring in serial, or linearly. However, multiple instances of the example process 1100 may occur in parallel. For purposes of explanation of the subject technology, the process 1100 will be discussed in reference to FIGS. 1-13.

At step 1102, the process 1100 may include receiving user-created content for a social media platform. At step 1104, the process 1100 may include tracking a performance of the user-created content. At step 1106, the process 1100 may include in response to the performance breaching a predefined threshold, promoting the user-created content to a higher tier level. The higher tier level may be associated with a higher performance threshold than the predefined threshold. At step 1108, the process 1100 may include tracking the performance of the user-created content at the higher tier level. At step 1110, the process 1100 may include in response to the performance breaching the higher performance threshold of the higher tier level, promoting the user-created content to an even higher tier level. The even higher tier level may be associated with an even higher performance threshold than the previous threshold. At step 1112, the process 1100 may include training a machine learning model on example input-output pairs. Each example input-output pair may include a representation of the user-created content and the performance that breaches at least the predefined threshold. At step 1114, the process may include determining, through the machine learning model, whether a popularity of the user-created content will grow exponentially.

For example, as described above in relation to FIGS. 1-13, at step 1102, the process 1100 may include receiving user-created content for a social media platform, through content receiving module 1008. At step 1104, the process 1100 may include tracking a performance of the user-created content, through performance tracking module 1010. At step 1106, the process 1100 may include in response to the performance breaching a predefined threshold, promoting the user-created content to a higher tier level, through content promotion module 1012. The higher tier level may be associated with a higher performance threshold than the predefined threshold. At step 1108, the process 1100 may include tracking the performance of the user-created content at the higher tier level, through performance tracking module 1010. At step 1110, the process 1100 may include in response to the performance breaching the higher performance threshold of the higher tier level, promoting the user-created content to an even higher tier level, through content promotion module 1012. The even higher tier level may be associated with an even higher performance threshold than the previous threshold. At step 1112, the process 1100 may include training a machine learning model on example input-output pairs. Each example input-output pair may include a representation of the user-created content and the performance that breaches at least the predefined threshold. At step 1114, the process may include determining, through the machine learning model, whether a popularity of the user-created content will grow exponentially.

According to an aspect, the content comprises at least one of a video, photo, image, multimedia, linked content, text, or post.

According to an aspect, the performance is determined based on at least one of clicks, likes, comments, shares, views, or reads.

According to an aspect, the process 1000 further includes performing an eligibility check when the user-created content is posted.

According to an aspect, the process 1000 further includes removing the user-created content from a curated group when the performance fails to breach the predefined threshold.

According to an aspect, the process 1000 further includes adding the user-created content to a curated group where the user-created content would have a high probability of performing at or above at least the predefined threshold.

According to an aspect, the curated group comprises users with similar personal or career interests, activities, backgrounds, social media connections, or real-life connections to each other.

According to an aspect, the process 1000 further includes causing display of the performance through a user interface.

According to an aspect, a curated list comprises at least the user-created content.

According to an aspect, machine learning is utilized to predict whether the user-created content will be shared to and/or viewed by millions of users.

According to an aspect, each higher tier level comprises a larger group of users than a previous tier level.

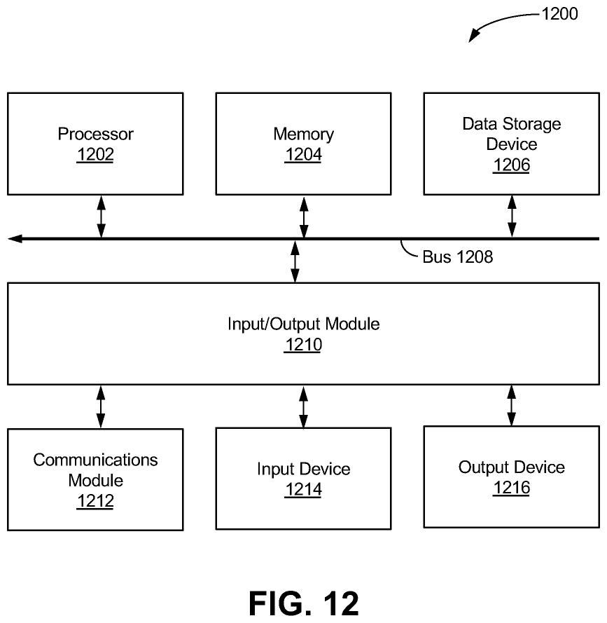

FIG. 12 is a block diagram illustrating an exemplary computer system 1200 with which aspects of the subject technology can be implemented. In certain aspects, the computer system 1200 may be implemented using hardware or a combination of software and hardware, either in a dedicated server, integrated into another entity, or distributed across multiple entities.

Computer system 1200 (e.g., server and/or client) includes a bus 1208 or other communication mechanism for communicating information, and a processor 1202 coupled with bus 1208 for processing information. By way of example, the computer system 1200 may be implemented with one or more processors 1202. Processor 1202 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1200 can include, in addition to hardware, code that creates an execution environment for the computer program in question, e.g., code that constitutes processor firmware, a protocol stack, a database management system, an operating system, or a combination of one or more of them stored in an included memory 1204, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 1208 for storing information and instructions to be executed by processor 1202. The processor 1202 and the memory 1204 can be supplemented by, or incorporated in, special purpose logic circuitry.

The instructions may be stored in the memory 1204 and implemented in one or more computer program products, i.e., one or more modules of computer program instructions encoded on a computer readable medium for execution by, or to control the operation of, the computer system 1200, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 1204 may also be used for storing temporary variable or other intermediate information during execution of instructions to be executed by processor 1202.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1200 further includes a data storage device 1206 such as a magnetic disk or optical disk, coupled to bus 1208 for storing information and instructions. Computer system 1200 may be coupled via input/output module 1210 to various devices. The input/output module 1210 can be any input/output module. Exemplary input/output modules 1210 include data ports such as USB ports. The input/output module 1210 is configured to connect to a communications module 1212. Exemplary communications modules 1212 include networking interface cards, such as Ethernet cards and modems. In certain aspects, the input/output module 1210 is configured to connect to a plurality of devices, such as an input device 1214 and/or an output device 1216. Exemplary input devices 1214 include a keyboard and a pointing device, e.g., a mouse or a trackball, by which a user can provide input to the computer system 1200. Other kinds of input devices 1214 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 1216 include display devices such as a LCD (liquid crystal display) monitor, for displaying information to the user.

According to one aspect of the present disclosure, the above-described gaming systems can be implemented using a computer system 1200 in response to processor 1202 executing one or more sequences of one or more instructions contained in memory 1204. Such instructions may be read into memory 1204 from another machine-readable medium, such as data storage device 1206. Execution of the sequences of instructions contained in the main memory 1204 causes processor 1202 to perform the process steps described herein. One or more processors in a multi-processing arrangement may also be employed to execute the sequences of instructions contained in memory 1204. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 1200 can include clients and servers. A client and server are generally remote from each other and typically interact through a communication network. The relationship of client and server arises by virtue of computer programs running on the respective computers and having a client-server relationship to each other. Computer system 1200 can be, for example, and without limitation, a desktop computer, laptop computer, or tablet computer. Computer system 1200 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer readable medium” as used herein refers to any medium or media that participates in providing instructions to processor 1202 for execution. Such a medium may take many forms, including, but not limited to, non-volatile media, volatile media, and transmission media. Non-volatile media include, for example, optical or magnetic disks, such as data storage device 1206. Volatile media include dynamic memory, such as memory 1204. Transmission media include coaxial cables, copper wire, and fiber optics, including the wires that comprise bus 1208. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 1200 reads game data and provides a game, information may be read from the game data and stored in a memory device, such as the memory 1204. Additionally, data from the memory 1204 servers accessed via a network the bus 1208, or the data storage 1206 may be read and loaded into the memory 1204. Although data is described as being found in the memory 1204, it will be understood that data does not have to be stored in the memory 1204 and may be stored in other memory accessible to the processor 1202 or distributed among several media, such as the data storage 1206.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include”, “have”, or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration”. Any embodiment described herein as “exemplary” is not necessarily to be construed as preferred or advantageous over other embodiments.

A reference to an element in the singular is not intended to mean “one and only one” unless specifically stated, but rather “one or more”. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for promoting social media content, comprising:
receiving user-created content for a social media platform;
tracking a performance of the user-created content;
in response to the performance breaching a predefined threshold, promoting the user-created content to a higher tier level, the higher tier level associated with a higher performance threshold than the predefined threshold;
tracking the performance of the user-created content at the higher tier level;
in response to the performance breaching the higher performance threshold of the higher tier level, promoting the user-created content to an even higher tier level, the even higher tier level associated with an even higher performance threshold than the higher performance threshold;
training a machine learning model on example input-output pairs, each example input-output pair comprising a representation of the user-created content and the performance that breaches at least the predefined threshold; and
determining, through the machine learning model, whether a popularity of the user-created content will grow exponentially.

2. The computer-implemented method of claim 1, wherein the user-created content comprises at least one of a video, photo, image, multimedia, linked content, text, or post.

3. The computer-implemented method of claim 1, wherein the performance is determined based on at least one of clicks, likes, comments, shares, views, or reads.

4. The computer-implemented method of claim 1, further comprising:
performing an eligibility check when the user-created content is posted.

5. The computer-implemented method of claim 1, further comprising:
removing the user-created content from a curated group when the performance fails to breach the predefined threshold.

6. The computer-implemented method of claim 1, further comprising:
adding the user-created content to a curated group where the user-created content has a high probability of performing above the predefined threshold.

7. The computer-implemented method of claim 6, wherein the curated group comprises users with similar personal or career interests, activities, backgrounds, social media connections, or real-life connections to each other.

8. The computer-implemented method of claim 1, further comprising:
causing display of the performance through a user interface.

9. The computer-implemented method of claim 1, wherein a curated list comprises at least the user-created content.

10. The computer-implemented method of claim 1, wherein the machine learning model is utilized to predict performance statistics of the user-created content.

11. A system configured for promoting social media content, the system comprising:
one or more hardware processors configured by machine-readable instructions to:
receive user-created content for a social media platform, the user-created content comprising at least one of a video, photo, image, multimedia, linked content, text, or post;
track a performance of the user-created content;
in response to the performance breaching a predefined threshold, promote the user-created content to a higher tier level, the higher tier level associated with a higher performance threshold than the predefined threshold;
track the performance of the user-created content at the higher tier level;
in response to the performance breaching the higher performance threshold of the higher tier level, promote the user-created content to an even higher tier level, the even higher tier level associated with an even higher performance threshold than the higher performance threshold;
training a machine learning model on example input-output pairs, each example input-output pair comprising a representation of the user-created content and the performance that breaches at least the predefined threshold;
determining, through the machine learning model, whether a popularity of the user-created content will grow exponentially; and
predicting, through the machine learning model, performance statistics of the user-created content.

12. The system of claim 11, wherein the performance is determined based on at least one of clicks, likes, comments, shares, views, or reads.

13. The system of claim 11, wherein the one or more hardware processors are further configured by machine-readable instructions to:
perform an eligibility check when the user-created content is posted.

14. The system of claim 11, wherein the one or more hardware processors are further configured by machine-readable instructions to:
remove the user-created content from a curated group when the performance fails to breach the predefined threshold.

15. The system of claim 11, wherein the one or more hardware processors are further configured by machine-readable instructions to:
add the user-created content to a curated group where the user-created content has a high probability of performing above the predefined threshold.

16. The system of claim 15, wherein the curated group comprises users with similar personal or career interests, activities, backgrounds, social media connections, or real-life connections to each other.

17. The system of claim 11, wherein the one or more hardware processors are further configured by machine-readable instructions to:
cause display of the performance through a user interface.

18. The system of claim 11, wherein a curated list comprises at least the user-created content.

19. A non-transient computer-readable storage medium having instructions embodied thereon, the instructions being executable by one or more processors to perform a method for promoting social media content, the method comprising:
receiving user-created content for a social media platform;
performing an eligibility check when the user-created content is received;
tracking a performance of the user-created content;
in response to the performance breaching a predefined threshold, promoting the user-created content to a higher tier level, the higher tier level associated with a higher performance threshold than the predefined threshold;
tracking the performance of the user-created content at the higher tier level;
in response to the performance breaching the higher performance threshold of the higher tier level, promoting the user-created content to an even higher tier level, the even higher tier level associated with an even higher performance threshold than the higher performance threshold;
training a machine learning model on example input-output pairs, each example input-output pair comprising a representation of the user-created content and the performance that breaches at least the predefined threshold;
determining, through the machine learning model, whether a popularity of the user-created content will grow exponentially;
predicting, through the machine learning model, performance statistics of the user-created content; and
causing display of the performance through a user interface.

20. The system of claim 19, wherein the performance is determined based on at least one of clicks, likes, comments, shares, views, or reads.
